(19) United States
(12) Patent Application Publication
(10) Pub. No.: US 2014/0122018 A1
(43) Pub. Date: May 1, 2014

(54) METHOD AND SYSTEM FOR OBSERVATION

(71) Applicants: Göran Sundholm, Tuusula (FI); Ville Sydänmaanlakka, Espoo (FI); Richard Eggleton, Vantaa (FI)

(72) Inventors: Göran Sundholm, Tuusula (FI); Ville Sydänmaanlakka, Espoo (FI); Richard Eggleton, Vantaa (FI)

(73) Assignee: ELSI TECHNOLOGIES OY, Vantaa (FI)

(21) Appl. No.: 14/123,437

(22) PCT Filed: May 31, 2012
(86) PCT No.: PCT/FI2012/050541

§ 371 Date: Dec. 2, 2013

(30) Foreign Application Priority Data
Jun. 3, 2011 (FI) 20115542
Jul. 6, 2011 (FI) 20115729

(51) Int. Cl. G01P 13/00; B66B 1/34

(52) U.S. Cl. CPC G01P 13/00; B66B 1/34
USPC 702/150; 187/388

(57) ABSTRACT

A system and method for monitoring presence, location, movement and/or attitude of one or more objects in a monitored space. The system includes sensors, which are arranged to certain part of the monitored space, e.g. to floor, wall or ceiling. The sensors are distance measuring ultrasonic sensors which produce measurement results and the system is configured to determine presence, location, movement and/or attitude of an object based on the measurement results.

### AREA OF THE INVENTION

The invention relates to method and system for monitoring and surveillance.

### BACKGROUND OF THE INVENTION

It's indispensable to monitor the condition of senior citizens in the home environment, if it's desired to make it possible for the senior citizens to cope longer at their home environment. The solutions presented so far have not turned out to be very useful. Safety wristband systems are commonly used. The weakness of these is that the user has to wear the wristband constantly and be able to push the alarm button in a case of an emergency. There are also wristbands which monitor health, but the problem of these are wrong alarms.

Solutions have also been tested in the prior art, in which a film comprising piezo electric material has been installed to the floor, which registers the vibration caused by the movement. The drawback of this is that it's not able to recognize a person who stays still. Also these kind of sensors are also sensitive to other vibrations of the building which leads to bad sensitivity or false alarms.

It's also known to use sensors installed in floor or under the floor, which sensors can recognize the presence and movement of humans without change of pressure or vibrations through capacitive sensors. The problem of these sensors installed under the floor is that they don't necessarily work with all kinds of floor materials. The floor installation of sensors requires also installation of floor surface material to the whole monitored area in which case installing floor sensors in an old space requires much work.

In prior art there has been presented also a possibility to use video cameras or motion detectors, which are based e.g. on recognition of infrared light, but also these solutions have not been proved to be successful. Also with cameras there are problematic questions concerning privacy.

### SHORT DESCRIPTION OF THE INVENTION

The invention presents a system and method for monitoring objects, which detects objects. The system according to the invention comprises at least two sensors capable of measurements of presence of an object. The sensors are ultrasonic sensors. The sensors according to the invention can be installed e.g. to the ceiling.

The system according to the invention further comprises measuring electronics which in combination with ultrasonic sensors produce sensor observations and a computer device which comprises processor and memory and which is suitable for processing sensor observations. The system can detect the object based on the sensor information and follow the object and detect events related to object based on one or more sensor observations. Sensor observation can be located e.g. based on the location of the sensor which made the observation.

The system according to the invention can be used e.g. for monitoring humans. One application is monitoring condition and state of senior citizens e.g. in their apartments or in old people's homes. Data collected by the system about condition and state of senior citizens can be sent e.g. to central control room or corresponding authority, who monitors certain space and/or people moving in that space.

By using method of claim 1 and system of claim 11, the problems of the present invention can be removed and an arrangement can be implemented which corresponds to the required usage needs. What characterizes the invention can be seen from the attached claims.

Benefit in the system of the invention compared to the prior systems is, among other things, that the floor material of the monitored area doesn't affect operation of the sensors. In case of the known capacitive floor sensors, the effect of the floor material to the measurement results is problem and leads to the situation where systems using capacitive floor sensors can't recognize fallen person from sanitary cabins.

In addition the system of the invention is easier to install afterwards to a monitored space than for example floor sensors which require often also renewing of the floor surfaces because ultrasonic sensors can be installed as a surface installation. This enables easy installation of ultrasonic sensors to e.g. sanitary cabins, because installation carried out as a ceiling installation has less requirements and limitations as floor installations of the sensors in sanitary cabins.

### SHORT DESCRIPTION OF THE FIGURES

The invention is illustrated with the following figures in which:

FIG. 1 presents a system according to one embodiment of the invention in an example space where several ultrasonic sensors are installed,

FIG. 2A presents a measuring event of the system according to one embodiment of the invention in which the measured object is standing in monitored space,

FIG. 2B presents measurement values according to the system of one embodiment of the invention in the event of FIG. 2A in which the measured object is standing in monitored space,

FIG. 3A presents a measuring event of the system according to one embodiment of the invention in which the measured object is lying in monitored space,

FIG. 3B presents measurement values according to the system of one embodiment of the invention in the event of FIG. 3A in which the measured object is lying in monitored space.

### DETAILED DESCRIPTION OF THE INVENTION

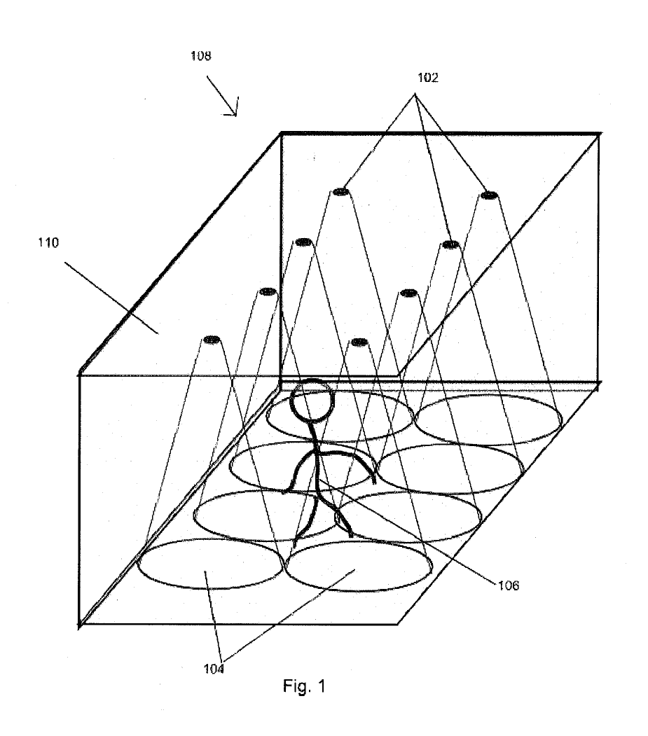

FIG. 1 presents one embodiment of the apparatus according to the invention in an example space where several ultrasonic sensors 102 are installed. Ultrasonic sensors can be installed e.g. to the ceiling 110 of the room. With several ultrasonic sensors 102 the floor surface area of the monitored space 108 can be covered with side-by-side-located measuring areas 104 of the ultrasonic sensors 102. Measuring area 104 is an area, in which area the ultrasonic sensor 102 is capable of detecting an object 106. The monitored space 108 can be the whole space or only a part of certain space. Monitored space can consist of e.g. one or more rooms and certain parts of the space, e.g. fixed installations such as closets, can be left outside the monitored space.

The detection of the object 106 can be carried out by using ultrasonic sensors 102 for distance measurement, in which case a distance from sensor to higher level than the floor can be regarded to mean that an object in the measuring area of the ultrasonic sensor 102. With precise measurement it can also be decided whether the object is high or low and in which attitude the object is.

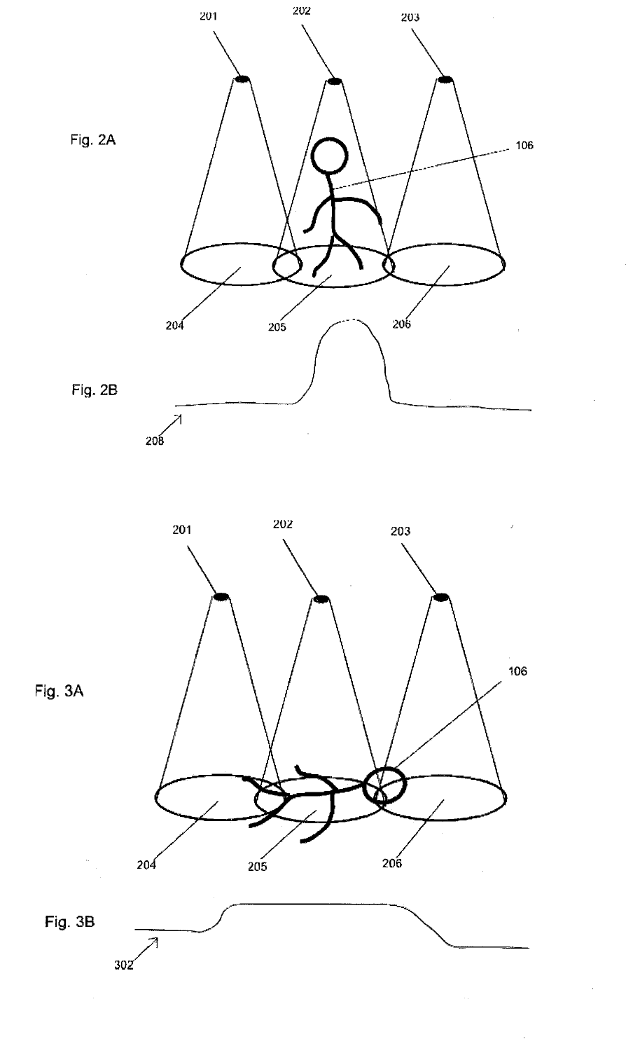

The system according to the invention can also combine data from many sensors and judge movement and attitude of the object from data of multiple sensors. FIG. 2A presents a situation where an object 106 in monitored space is being measured with the system. The object is standing in the space and under ultrasonic sensor 202 in its measuring area 205. Ultrasonic sensors 201, 203 are beside the ultrasonic sensor 202 but the object is not on these sensors' measuring areas 204, 206. FIG. 2B presents measured height values carried out by distance measurement from ultrasonic sensors 201, 202, 203 in the situation presented in FIG. 2A. It can be seen from the distance measurement results presented in FIG. 2B, that height measurement produces deviating result from floor level only at the measuring area 205 of the ultrasonic sensor 202 but not at measurement areas 204, 206 of ultrasonic sensors 201, 203. In this case the system can form information that the object is in the monitored space in measuring area 205 of the ultrasonic sensor 202 and that the object is standing.

FIG. 3A presents a situation where an object 106 in monitored space is being measured with the system, wherein the object is fallen in measuring areas 204, 205, 206 of ultrasonic sensors 201, 202, 203. FIG. 3B presents measured height values carried out by distance measurement from ultrasonic sensors 201, 202, 203 in the situation presented in FIG. 3A. It can be seen from the distance measurement results presented in FIG. 3B, that height measurement produces deviating result from floor level on all measuring areas 204, 205, 206 of the ultrasonic sensors 201, 202, 203. However the measured height is smaller than the measured height measurement result of the standing object measured in FIG. 2B. In this case the system can form information that the object is in the monitored space in measuring areas 204, 205, 206 of the ultrasonic sensors 201, 202, 203 and that the object is in horizontal attitude.

The system of the invention further comprises measuring electronics which produces sensor observations with the help of ultrasonic sensors and a central unit, comprising processor and memory, which is capable of processing sensor observations and which is for example a data processing apparatus. The central unit of the system can control one or multiple ultrasonic sensor or sensor groups, wherein one sensor group means ultrasonic sensors which are e.g. in the same space, such as a room.

Central unit and measurement electronics can be integrated to the sensors or the can be placed in separate unit or units.

In many embodiments it's advantageous to first perform a mapping of unchanged space, i.e. to map measurement results of the ultrasonic sensors when essentially unmoving and unchanging objects and structures are on their places. This is the situation in an apartment when the furniture is in place but no persons, pets or robots are in the apartment. This mapped data can be stored to the system, e.g. to memory which is in the central unit or via communication network to a memory device which can be e.g. in control or service center. For this purpose the arrangement has to have memory means which can be in central unit or connected to central unit via communication network.

In one embodiment of the invention the system performs mapping of the unchanged space constantly or at predefined intervals, in which case the system can recognize the changes of the space caused by e.g. new furniture or change of places of furniture. This way the system can adapt bit by bit to the changes in the monitored space.

Furthermore with the ultrasonic sensors of the system it's possible to monitor the movement of the object 106. For this operation the central unit of the system comprises the required software and information about the characteristic features of the observed signals. In general the central unit can judge information on e.g. position, speed, moving direction, state and attitude of the object from signal received via the sensor.

The data collected by the system can be sent e.g. to control center or other authority who controls the space and/or people in the space. The transfer of information between the system and certain receiver can be done using telephone connection, wireline broadband connection, wireless connection or optical or acoustical connection. It's advantageous to take matters relating to data security and privacy into account in data transfer, in which also several orders of authorities are related. The data transfer can be done e.g. by the central unit of the system. Multiple ultrasonic sensors or sensor groups can be connected to the central unit vie wireline or wireless connection.

It is possible that a part of the functions of the central unit are executed elsewhere via data connection, e.g. in central control facility of service center.

The system of the invention can be used to monitor security e.g. in the following way: The inhabitant of the apartment goes to sleep to his bed in the evening. If someone arrives to the apartment after this, the system performs alarm procedures which can be pre configured. The alarm procedures can comprise e.g. starting of alarm signaling (buzzer, light, siren, alarm bell), contacting alarm or service center, monitoring person or relative. For carrying out these tasks the system has to have means needed for processing time information such as e.g. clock circuit.

In general at least a part of the ultrasonic sensors of the system are placed to or in the vicinity of surfaces of such places where the object 106 has access, e.g. floor, wall, door or ceiling surfaces.

The examples describe above are mainly related to the monitoring in home environment. It's natural that the system can be used also in other places, e.g. in museums, banks, industry or office spaces, ware houses, prisons, pipes, sport and fitness facilities, schools, and animal shelters. In following these spaces and other possible target spaces are called generally as monitored spaces and procedures relating to monitoring are called monitoring procedures.

The system can also be used to monitor spaces, in which the object 106 doesn't have or shouldn't have access. Then at least a part of the ultrasonic sensors are placed in the vicinity of such spaces, such as in the surroundings of dangerous or valuable articles, to which or to vicinity of such articles the object 106 doesn't have access or shouldn't have access or reason to go.

The system can also control features of the monitored space such as lighting, air conditioning, access control, locking, other alarm, guiding and surveillance systems or robot systems in the area. Based on the measurement results of the ultrasonic sensors of the system, guiding commands and e.g. location information can be delivered to a robot moving in the monitored space. In this case the system comprises means needed for this such as Bluetooth, WLAN or other transceiver equipment.

The system of the invention can be used in parallel with a system based on floor sensors and the control and management of the systems can be done with same hardware and software.

In one embodiment of the invention the ultrasonic sensors can be attached to a strip, e.g. to a strip described in publication WO98/23896, which is attachable e.g. to a ceiling. The strip can comprise also other components along with the ultrasonic sensors.

The system according to the invention can be used also to route or guide people, wherein ultrasonic sensors are used to gather sensor information needed for guiding. The guiding can be done using light strips or other light signals. The system of the invention can be used. e.g. to control queues, in which case it's possible to monitor number of people in the queue and/or whether the queues are full or empty. With the information gathered using ultrasonic sensors the people can be guided e.g. to empty queues. The queue control can be implemented e.g. with the signals described in application WO2012084248 and in the way described in application WO2012084248. The ultrasonic sensors according to the invention can be used instead of floor sensors described in WO2010084248 or with the floor sensors.

In one embodiment of the invention the system can guide the object with light signals, light strips or other guides based on the location information of the object received from the ultrasonic sensors and/or other sensors. The speed of guiding can be adjusted to be same as the speed the object is moving and the guiding can be done dynamically in all areas where the guiding system is installed.

In one embodiment the system of the invention can be used to control elevators. In the embodiment for elevator control at least one ultrasonic sensor is arranged to every floor in the elevator lobby in front of the elevators, which ultrasonic sensor recognizes number of the people waiting for elevator and/or makes an approximation of the number of the people. The system also aims to guide people optimally to the elevators with the guiding system based on the moving direction of the people. In one embodiment the elevator control can also be optimized based on the energy consumption. Elevator control can be done e.g. in the way described in publication WO2011012768. The ultrasonic sensors according to the invention can be used instead of floor sensors described in WO2011012768 or with the floor sensors.

Accordingly the invention relates to a method of monitoring presence, location, movement and/or attitude of one or more objects in a monitored space 108. Sensors, which are ultrasonic sensors 102, 201, 202, 203 are located to certain lo part of the monitored space 108, e.g. to floor, wall or ceiling 110. The method comprises steps of: measuring the monitored space 108 with ultrasonic sensors 102, 201, 202, 203 and determining presence, location, movement and/or attitude of an object 106 based on the measurement results of the ultrasonic sensors 102, 201, 202, 203.

In one embodiment of the invention ultrasonic sensors 102, 201, 202, 203 measure distance downwards from the sensor and presence, location, movement and/or attitude of the object 106 is determined based on distance measurement results 208, 302.

In one embodiment of the invention the system comprises a control center and wherein the object is human, e.g. old person, and determined presence, location, movement and/or attitude information of the object 106 is sent to control center.

In one embodiment of the invention movement of the object 106 is determined based on measurement results of at least two ultrasonic sensors 102, 201, 202, 203, which measurement results are simultaneous or consecutive.

In one embodiment of the invention the measuring areas 104, 204, 205, 206 of the side by side and/or consecutively installed ultrasonic sensors 102, 201, 202, 203 essentially cover the area of monitored space 108.

In one embodiment of the invention one or more objects in the monitored space are tracked based on the measurement results of the ultrasonic sensors 102, 201, 202, 203.

In one embodiment of the invention mapping of the unchanged space is done before taking the system into use so that information about fixed objects of the monitored space is obtained.

In one embodiment of the invention mapping of the unchanged space is done continuously or at defined intervals so that the system can adapt to the changes in the monitored space, for example to new furniture and/or moving of the furniture.

In one embodiment of the invention the information derived based on the measurement results from the ultrasonic sensors 102, 201, 202, 203 is evaluated by criteria which are fixed, pre-set or adaptable and certain actions, such as e.g. control or alarm actions, are made based on the evaluation.

In one embodiment of the invention the measurement results or information derived from measurement results are stored to memory means to detect time dependencies of monitored spaces and behavior of objects, e.g. such that information registered at certain point of time derived from one or more measurement results is stored and this information is used as a comparison information for information derived at later point of time.

In one embodiment of the invention the measurement results from the ultrasonic sensors 102, 201, 202, 203 are used as sensor information for guiding people and wherein guides, such as light guides, have been arranged to the monitored space and people are guided with the guides based on the measurement results of the ultrasonic sensors 102, 201, 202, 203.

In one embodiment of the invention elevators are controlled in an elevator system based on the measurement results of the ultrasonic sensors 102, 201, 202, 203, the elevator system comprising multiple elevators and one or more ultrasonic sensors 102, 201, 202, 203 are arranged to each waiting area in each floor, wherein ultrasonic sensors 102, 201, 202, 203 produce measurement results about number of passengers waiting for an elevator and control means for elevators are controlling movement of the elevators based on the measurement results of the ultrasonic sensors 102, 201, 202, 203.

In one embodiment of the invention the ultrasonic sensors 102, 201, 202, 203 produce measurement results about presence and number of the passengers waiting for the elevator at least in the corresponding waiting area and elevator control means receive measurement results of the ultrasonic sensors 102, 201, 202, 203 about presence and number of the passengers waiting for the elevator in each floor and control movement of the elevators based on the measurement results received from the ultrasonic sensors 102, 201, 202, 203.

The invention relates also to a system for monitoring presence, location, movement and/or attitude of one or more objects in a monitored space 108. System comprises sensors, and sensors are located to certain part of the monitored space 108, e.g. to floor, wall or ceiling 110. The sensors are distance measuring ultrasonic sensors 102, 201, 202, 203. The ultrasonic sensors 102, 201, 202, 203 produce measurement results and the system is configured to determine presence, location, movement and/or attitude of an object 106 based on the measurement results.

In one embodiment of the invention ultrasonic sensors 102, 201, 202, 203 are sensors measuring distance downwards from the sensor and the system is configured to determine presence, location, movement and/or attitude of the object 106 based on distance measurement results 208, 302.

In one embodiment of the invention the system comprises a control center and wherein the object is human, e.g. old person, and the system is configured to send determined presence, location, movement and/or attitude information of the object 106 to control center.

In one embodiment of the invention the system is configured to determine movement of the object 106 based on measurement results of at least two ultrasonic sensors 102, 201, 202, 203, which measurement results are simultaneous or consecutive.

In one embodiment of the invention the system is configured to track one or more objects in the monitored space based on the measurement results of the ultrasonic sensors 102, 201, 202, 203.

In one embodiment of the invention the ultrasonic sensors 102, 201, 202, 203 are installed of the side by side and/or consecutively and the measuring areas 104, 204, 205, 206 of the ultrasonic sensors 102, 201, 202, 203 essentially cover the area of monitored space 108.

In one embodiment of the invention the system is configured to perform mapping of the unchanged space before the system is taken into use so that information about fixed objects of the monitored space is obtained.

In one embodiment of the invention the system is configured to perform mapping of the unchanged space continuously or at defined intervals so that the system can adapt to the changes in the monitored space, for example to new furniture and/or moving of the furniture.

In one embodiment of the invention the system is configured to evaluate measurement results from the ultrasonic sensors 102, 201, 202, 203 and perform certain actions, such as e.g. control or alarm actions, based on the evaluation.

In one embodiment of the invention the system comprises memory means in which the system is configured to store the measurement signal or information derived from measurement signal to detect time dependencies between monitored spaces 108 and behavior of objects 106.

In one embodiment of the invention the system comprises central unit to process the obtained measurement results from the ultrasonic sensors 102, 201, 202, 203 and to derive information relating to characteristics of the object 106. In one embodiment of the invention the system comprises means for forwarding the derived information of the object 106 by using wireline or wireless communication link.

In one embodiment of the invention the system comprises or is in connection with means for storing location information relating to sensor.

In one embodiment of the invention the ultrasonic sensors 102, 201, 202, 203 are attached to a strip, which can be fixed for example to floor, wall and/or ceiling 110.

In one embodiment of the invention the system comprises guides for guiding is people, such as light guides and the system is configured to guide people based on the measurement results of the ultrasonic sensors 102, 201, 202, 203.

In one embodiment of the invention the system is configured to control elevators in an elevator system based on the measurement results of the ultrasonic sensors 102, 201, 202, 203, the elevator system comprising multiple elevators and one or more ultrasonic sensors 102, 201, 202, 203 are arranged to each waiting area in each floor, wherein ultrasonic sensors 102, 201, 202, 203 are configured to produce measurement results about number of passengers waiting for an elevator and control means for elevators are configured to control movement of the elevators based on the measurement results of the ultrasonic sensors 102, 201, 202, 203.

In one embodiment of the invention the ultrasonic sensors 102, 201, 202, 203 are configured to produce measurement results about presence and number of the passengers waiting for the elevator at least in the corresponding waiting area and elevator control means receive measurement results of the ultrasonic sensors 102, 201, 202, 203 about presence and number of the passengers waiting for the elevator in each floor and to control movement of the elevators based on the measurement results received from the ultrasonic sensors 102, 201, 202, 203.

It is obvious to the person skilled in the art that the invention is not limited to the embodiments presented above, but that it can be varied within the scope of the claims presented below. The characteristic features possibly presented in the description in conjunction with other characteristic features can also, if necessary, be used separately to each other.

1. Method of monitoring presence, location, movement and/or attitude of one or more objects in a monitored space wherein sensors are located to certain part of the monitored space, e.g. to floor, wall or ceiling wherein the sensors are ultrasonic sensors, and the method comprises steps of:
measuring the monitored space with ultrasonic sensors,
determining presence, location, movement and/or attitude of an object based on the measurement results of the ultrasonic sensors.

2. A method according to claim 1 wherein ultrasonic sensors measure distance downwards from the sensor and presence, location, movement and/or attitude of the object is determined based on distance measurement results of the ultrasonic sensors.

3. A method according to claim 1 wherein the system comprises a control center and wherein the object is human, e.g. old person, and determined presence, location, movement and/or attitude information of the object is sent to control center.

4. A method according to claim 1 wherein movement of the object is determined based on simultaneous or consecutive measurement results of at least two ultrasonic sensors.

5. A method according to claim 1 wherein the measuring areas of the side by side and/or consecutively installed ultrasonic sensors essentially cover the area of monitored space.

6. A method according to claim 1 wherein one or more objects in the monitored space are tracked based on the measurement results of the ultrasonic sensors.

7. A method according to claim 1 wherein mapping of the unchanged space is done before taking the system into use so that information about fixed objects of the monitored space is obtained.

8. A method according to claim 1 wherein mapping of the unchanged space is done continuously or at defined intervals so that the system can adapt to the changes in the monitored space, for example to new furniture and/or moving of the furniture.

9. A method according to 1 wherein the information derived based on the measurement results from the ultrasonic sensors is evaluated by criteria which are fixed, pre-set or adaptable and certain actions, such as e.g. control or alarm actions, are made based on the evaluation.

10. A method according to claim 1 wherein the measurement results or information derived from measurement results are stored to memory means to detect time dependencies of monitored spaces and behavior of objects, e.g. such that information registered at certain point of time derived from one or more measurement results is stored and this information is used as a comparison information for information derived at later point of time.

11. A method according to claim 1 wherein the measurement results from the ultrasonic sensors are used as sensor information for guiding people and wherein guides, such as light guides, have been arranged to the monitored space and people are guided with the guides based on the measurement results of the ultrasonic sensors.

12. A method according to claim 1 wherein elevators are controlled in an elevator system based on the measurement results of the ultrasonic sensors, the elevator system comprising multiple elevators and one or more ultrasonic sensors are arranged to each waiting area in each floor, wherein ultrasonic sensors produce measurement results about number of passengers waiting for an elevator and control means for elevators are controlling movement of the elevators based on the measurement results of the ultrasonic sensors.

13. A method according to claim 12 wherein the ultrasonic sensors produce measurement results about presence and number of the passengers waiting for the elevator at least in the corresponding waiting area and elevator control means receive measurement results of the ultrasonic sensors about presence and number of the passengers waiting for the elevator in each floor and control movement of the elevators based on the measurement results received from the ultrasonic sensors.

14. A system for monitoring presence, location, movement and/or attitude of one or more objects in a monitored space, the system comprising sensors, wherein sensors are arranged to certain part of the monitored space, e.g. to floor, wall or ceiling wherein:
the sensors are distance measuring ultrasonic sensors and the ultrasonic sensors produce measurement results and the system is configured to determine presence, location, movement and/or attitude of an object based on the measurement results.

15. A system according to claim 14 wherein ultrasonic sensors are sensors measuring distance downwards from the sensor and the system is configured to determine presence, location, movement and/or attitude of the object based on distance measurement results.

16. A system according to claim 14 wherein the system comprises a control center and wherein the object is human, e.g. old person, and the system is configured to send determined presence, location, movement and/or attitude information of the object to control center.

17. A system according to claim 14 wherein the system is configured to determine movement of the object based on simultaneous or consecutive measurement results of at least two ultrasonic sensors.

18. A system according to claim 14 wherein the system is configured to track one or more objects in the monitored space based on the measurement results of the ultrasonic sensors.

19. A system according to claim 14 wherein the ultrasonic sensors are installed of the side by side and/or consecutively and the measuring areas of the ultrasonic sensors essentially cover the area of monitored space.

20. A system according to claim 14 wherein system is configured to perform mapping of the unchanged space before the system is taken into use so that information about fixed objects of the monitored space is obtained.

21. A system according to claim 14 wherein the system is configured to perform mapping of the unchanged space continuously or at defined intervals so that the system can adapt to the changes in the monitored space, for example to new furniture and/or moving of the furniture.

22. A system according to claim 14 wherein the system is configured to evaluate measurement results from the ultrasonic sensors and perform certain actions, such as e.g. control or alarm actions, based on the evaluation.

23. A system according to claim 14 wherein the system comprises memory means in which the system is configured to store the measurement signal or information derived from measurement signal to detect time dependencies between monitored spaces and behavior of objects.

24. A system according to claim 14 wherein the system comprises central unit to process the obtained measurement results from the ultrasonic sensors and to derive information relating to characteristics of the object.

25. A system according to claim 14 wherein the system comprises means for forwarding the derived information of the object by using wireline or wireless communication link.

26. A system according to claim 14 wherein the system comprises or is in connection with means for storing location information relating to sensor.

27. A system according to claim 14 wherein the ultrasonic sensors are attached to a strip, which can be fixed for example to floor, wall and/or ceiling.

28. A system according to claim 14 wherein the system comprises guides for guiding people, such as light guides and the system is configured to guide people based on the measurement results of the ultrasonic sensors.

29. A system according to claim 14 wherein the system is configured to control elevators in an elevator system based on the measurement results of the ultrasonic sensors, the elevator system comprising multiple elevators and one or more ultrasonic sensors are arranged to each waiting area in each floor, wherein ultrasonic sensors are configured to produce measurement results about number of passengers waiting for an elevator and control means for elevators are configured to control movement of the elevators based on the measurement results of the ultrasonic sensors.

30. A system according claim 28 wherein the ultrasonic sensors are configured to produce measurement results about presence and number of the passengers waiting for the elevator at least in the corresponding waiting area and elevator control means receive measurement results of the ultrasonic sensors about presence and number of the passengers waiting for the elevator in each floor and to control movement of the elevators based on the measurement results received from the ultrasonic sensors.
